(19) United States
(12) Patent Application Publication
(10) Pub. No.: US 2025/0323595 A1
(43) Pub. Date: Oct. 16, 2025

(54) MOBILE, SOLAR POWERED POWER STATION SYSTEM

(71) Applicant: Sharon MAXWELL, Portland, OR (US)

(72) Inventor: Sharon MAXWELL, Portland, OR (US)

(21) Appl. No.: 19/036,950

(22) Filed: Jan. 24, 2025

Related U.S. Application Data
(60) Provisional application No. 63/624,382, filed on Jan. 24, 2024.

(51) Int. Cl. H02S 20/30; B60S 9/02; B62D 63/06; H02J 7/35; H02S 10/20

(52) U.S. Cl. CPC H02S 20/30; H02J 7/35; H02S 10/20; B60S 9/02; B62D 63/06

(57) ABSTRACT

Some embodiments are directed to a power station system that is mobile, able to charge using solar power, able to produce AC and DC current, and/or transportable by being towed such as behind a consumer vehicle. In various embodiments, the system contains a battery that is capable of meeting certain power needs, such as the needs of a jobsite, a medium sized home, etc. The solar power can be derived from a solar panel array that is configurable to generate power in any given environment. The system can also include wheels so that it can be towed, such as a two-axle trailer and a series of outriggers for support and ease of transportation. This unit also can include an inceptor to receive the garnered electricity into a storage device for future uses.

### CROSS REFERENCE TO RELATED APPLICATION(S)

This application claims the priority benefit under 35 U.S.C. § 119 of U.S. Provisional Application No. 63/624,382, filed on Jan. 24, 2024, the contents of which are hereby incorporated in their entireties by reference.

### BACKGROUND

An enormous number of modern devices, such as tools, communication devices, lights, HVAC equipment, etc., need electricity to operate. Some require DC power while others run on AC power. Thus, sources of power are necessary to enable the operation of such devices.

### SUMMARY

It may be advantageous to provide flexibility in the supply of electric power in various contexts.

In one context, it may be helpful to provide service electricity needs in underdeveloped areas or areas affected by disasters that may be difficult to meet. Access to on demand electricity in these and remote areas can be vital. One common source of such electricity is the internal combustion engine. Internal combustion engines can be configured to consume fuels such as oil, diesel, gasoline, ethanol, and natural gas. These fuels may be hard to source in some situations or locations. Additionally, storage of these fuels can be costly, hazardous to the environment and possibly dangerous. Fossil fuel driven auxiliary power generators are well known for providing power in remote locations. Generally fossil fuel driven auxiliary power generators use an internal combustion engine that converts stored chemical energy into mechanical energy and then into electrical energy. These generators vary in size and capacity. Additionally, these generators may be loud, create nauseous gasses, and create vibrations that could be considered a nuisance. Typical battery power stations have limited capacity and typically require a fossil fuel driven generator to charge. Thus, various of the embodiments are configured to address or solve some of these issues.

### Transportable

However, the above merely focuses on one context. Embodiments are intended to include or otherwise cover any possible context for providing electric power.

Some embodiments are intended to cover a fully or partially mobile power system that can be transported to a certain location in need of power. Embodiments are intended to cover any possible structure that allows the system to be movable. In some embodiments, the system is configured to be towed behind another vehicle or transportation source. For example, in some of these embodiments, the system can be towed by a land vehicle, such as a car, truck, military vehicle, train, bus, etc. Some of these embodiments include a simple structure, such as a single or multi-axle structure with wheels to allow the system to be towed behind the land vehicle.

However, other embodiments include structures that facilitate towing behind any of the other cited land vehicles. Still other embodiments can be configured to be towed behind non-land vehicles, such as being towed or otherwise moved with or behind sea vessels. Some embodiments are configured to include structures to be moved via aerial vehicles, such as planes, drones, etc. Embodiments can even be configured for movement outside the atmosphere, e.g., in space.

Importantly, the embodiments are not intended to be limited to any specific type of structures enabling movement. For example, some embodiments include structures that enable the system to be self-movable, such as on land, water, air, space, etc. Embodiments are intended to include or otherwise cover any known or later developed structures for enabling this type of movement of the system.

### Electricity Generation and Storage of Electricity

Some embodiments include solar panels for obtaining and/or generating electric power and storing electricity. Some of these embodiments include solar panels, arrays, or other structures using known, related art, or later developed solar capture technologies.

The embodiments that generate power via solar technologies can be configured to enhance or optimize power generation. For example, some of these embodiments include software and other hardware to enhance solar power generation. In some of these embodiments, the solar panels can be manually or automatically movable to enhance the solar panel's capture of sunlight. Embodiments are intended to cover all known, related art, or later developed technologies for enhancing sunlight capture or otherwise enhancing the solar panel power generation efficiency.

However, other embodiments generate power using non-solar technologies, such as other green technologies, including but not limited to wind power, nuclear power, hydrogen, etc. In fact, embodiments are intended to cover any known, related art, or later developed technologies for generating electric power, including green technologies and other technologies typically not associated with green technologies.

In fact, some embodiments generate power in ways that are associated with the mode of transportation of the system. Sas an example, some of the embodiments that are movable in a water environment can generate electric power relevant to water environments, such as using technologies that generate power from water movements such as via waves. Similarly, some embodiments that are movable via air can generate electric power via air movement such as via turbines, blades, etc.

However, some embodiments may not necessarily include such an electric power storage system, such as in embodiments where the electric power is used concurrently with being generated.

### Power Storage

Some embodiments include an electric power storage system to store the electric power generated. Emblements are intended to include any known, related art, or later developed electric power storage system, including but not limited to any and all battery technologies. However, embodiments are not limited to storing power via battery technologies, and thus some embodiments can store power or other types of energy (e.g., potential energy, etc.) in other ways. In some of those embodiments, the power can then be converted to via any known, related art, or later developed power converter.

### Electric Power Types and Connections

Some embodiments are configured to only supply and provide AC electrical power, while others are confined to only supply and provide DC electric power. Other embodiments are configured to supply and provide both AC and DC electric power. Embodiments are intended to include apparatus for generating and providing DC and/or AC power at any voltage and amperage.

Embodiments are intended to be configured to include connections to enable the supply of electric power to any number and any known, related art, or later developed electric devices. In other words, there is no limit to the number of devices and types of devices that are connectable to the system to enable the devices to receive electric power. In fact, some embodiments are configured to be directly connected to devices for the supply of electrical power, others are configured to be indirectly connected to the devices, while still others provide electric power without a direct or indirect connection.

### BRIEF DESCRIPTION OF THE DRAWINGS

FIG. 1 is a top plan view of an exemplary embodiment of the power station system.

FIG. 2 is a side plan view of an exemplary embodiment of the power station system.

FIG. 3 is a plan view of an exemplary power station system's control and information panel.

FIG. 4 is a schematic of exemplary working principles of an exemplary power station system.

### DETAILED DESCRIPTION

The invention is related to a mobile, solar powered power station that can be transported to a desired location and positioned such that it maximizes the solar panel's power generation. The system comprises several batteries, a solar panel array, a solar charger system, a crank system designed to adjust the orientation of the solar panel array, a series of outriggers, and a two-axle trailer. The system is sufficiently compact that it can be transported to remote locations where other means of electrical power are impractical.

The system is sized to be towed behind a consumer vehicle. The system can meet the power needs of a medium sized home but is able to at other locations such as work sites. The system's outriggers provide stability to the system when lowered to the ground. Inclement weather such as heavy rain or snow fall, and high winds will not damage the system.

The solar panel array is height and orientation adjustable. The solar panel array changes orientation to more efficiently generate electrical power. An onboard processor calculates how to change the orientation of the solar panel array to generate electrical power more efficiently. The processor is also able to bring down the solar panels when no sunlight is detected or when the batteries are completely charged. A manual crank system is available as an alternative if some issue prevents the processor from changing the orientation of the solar panel array or if the user desires. The system is ruggedized against inclement weather.

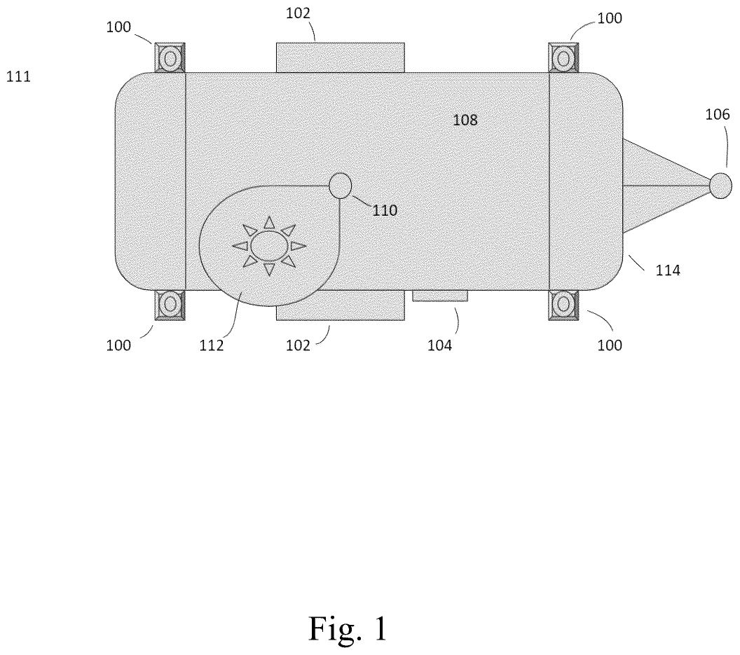

Relating to FIGS. 1-4. The solar trailer system is an all-encompassing mobile power solution comprising a solar panel array 112 on an extendable pole 110, battery 402, solar charge converter, and a two-axle trailer 206 with outriggers 100. The Solar Trailer System's solar panel array 112 is mounted on a transportable two-axle trailer 206, allowing the system to power small to mid-sized homes in rural areas without other means of electrical power. The Solar Trailer System's combination of extendable pole 110 and manual crank shaft 104 allow the solar panel array 112 to be raised and rotated to an ideal angle facing the sun without obstruction from direct sunlight. There are six electrical outlets 302 and 304 lining the Solar Trailer System to power home appliances via extension cables. The two-axle trailer 206 is outfitted with four outriggers 100 at the four corners of the trailer, meant to stabilize the system once it is positioned.

FIG. 1 is a top down illustration of one embodiment of the power station system 111. A power station system 111 has several outriggers 100 that are configured to provide additional support and stability when the power station system 111 is parked for use. It is understood that the power station system can contain a plurality of outriggers 100. The power station system 111 has two wheel wells 102 that cover tires 202 and the axles of the two-axle trailer 206. A crank system 104 which is mechanically connected to a solar panel array 112 and an extendable pole 110. A trailer hitch 106 configured to allow the power station system 111 to be towed behind vehicles. A main body 108 of the power station system 100 positioned on top of the two-axle trailer 206. The main body 108 contains the batteries, DC/AC inverter, and other associated components. The extendable pole 110 is mechanically connected to both the solar panel array 112 and the crank system 104 and is able to extend or retract. The extending or retracting adjusts the position, angle, and orientation of the solar panel array 112. Together the extendable pole 110 and crank system 104 are able to change the orientation of the solar panel array 112 to maximize power output based on the angle of incoming solar rays. An onboard processor can automatically control this change in orientation or the user can set the angle themselves via a handle 200 connected to the crank system 104. When no sunlight is detected, the processor can automatically bring down the solar panel array 112. In one embodiment the solar panel array 112 can consist of circular solar panels. In another embodiment, the solar panel array 112 can form a circle as a whole when it deploys a plurality of solar panels in a particular orientation. The extendable pole 110 can be made from various materials such as fiberglass, carbon fiber, aluminum, or steel. Carbon fiber, aluminum, or steel are materials that could be used for the tongue, main beam, cross member, perimeter, and brace of the two axle trailer. Rectangular tubes, I-Beam, C-Channels, or L-Angles are also structures that can be used for a strong basis of the two axle trailer.

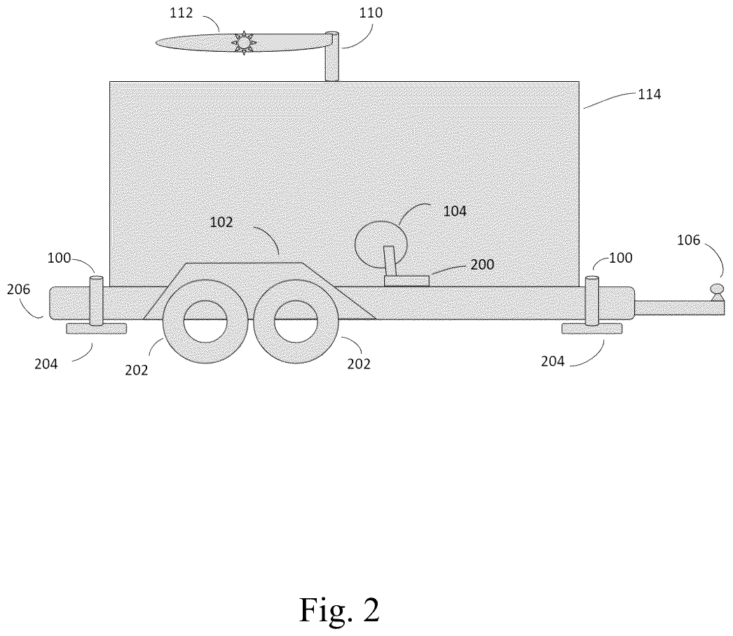

FIG. 2 is a side view illustration of one embodiment of the power station system. The main body 108 is positioned on a main platform of the two-axle trailer 206. The main body 108 has a crank system 104 with a crack handle 200. The outriggers 100 each have a baseplate 204 that increases the outriggers 100 footprint and decreases the ground pressure. Tires 202 and a trailer hitch 106 allow the power station system 111 to be towed behind a vehicle to a different location. Together, outriggers 100 and baseplates 204 allow the power station system to stabilize itself when the outriggers are down. In some embodiments, the baseplates 204 of the outriggers 100 are made of steel. The power station system is ruggedized against inclement weather conditions to include elevated temperatures, cold temperatures, and high winds.

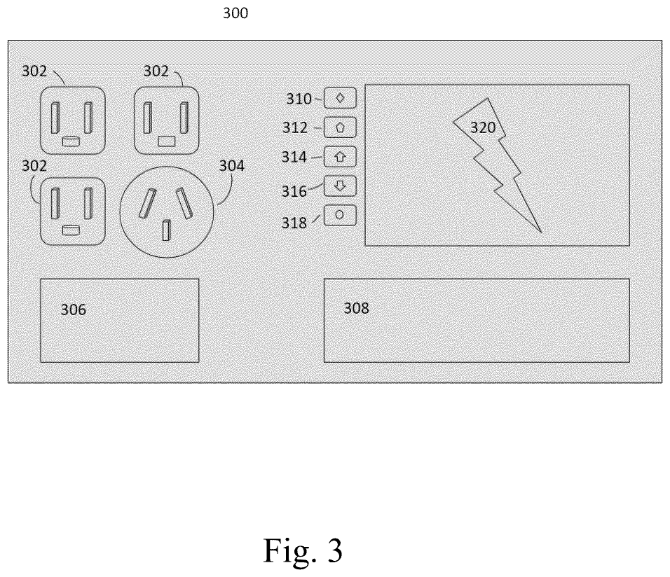

FIG. 3 is an illustration of one embodiment of the power station system's control and information panel 300. The control and information panel 300 of the power station system could be attached to a side of the main body 108 of the power station system. There are several embodiments of outlets or electrical plugs. A first embodiment of an electrical plug 302. A second embodiment of an electrical plug 304. There are several access panels and displays including a first access panel 306 and a first display 308, a second display 320. There are also a series of buttons each having an action including: a first button 310 having a first action, a second button 312 having a second action, a third button 314 having a third action, a fourth button 316 having a fourth action, a fifth button 318 having a fifth action. The second action possibly being a unique action. The third action possibly being a unique action. The fourth action possibly being a unique action. The fifth action possibly being a unique action. The power station system 111 can power external tools that can plug into one of the electrical plugs. The power station system 111 can be used to power a home. The power station system is designed to meet the power needs of a medium sized home. In one embodiment the first embodiment of the electrical plug can feature a standard 120 W outlet. In another embodiment the first embodiment of the electrical plug can feature a 220 W outlet. In one embodiment the power station system may have up to six electrical outlets of various types. In one embodiment the power station system can be accessed remotely via an onboard wireless connection.

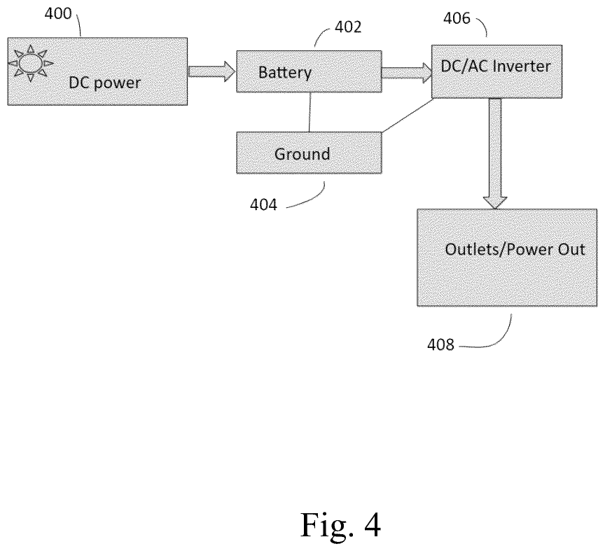

FIG. 4 is a simplified illustration of the working principles of the power station system 111. DC power 400 provided by the solar panel array 112 charges a battery 402 held within the main body 108. The battery 402 has a grounding 404 and a DC/AC inverter 406. Outlets/power out comes from the DC/AC inverter 408.

Further, non-limiting, description of aspects of the various embodiments are described below.

The power capacity of the batteries can be any known capacity and can generally be sufficient for the batteries to last in a range between 24 to 48 hours. The charge time of the batteries can be between 15 minutes to 1 hour, or any other range in accordance with the manufacturing specifications of the battery. The power station system can run without solar for at least 3 days. The weight of the system can be between 300 lbs to 750 lbs depending on the various component weights. The system may have shocks and tipping components for stability. The battery, charger station, generator and computer for data capture can all be part of the system and can be one integrated system. The power station can be configured for multi-faceted use as listed and EV charge for limited charge.

1. A solar panel system, comprising:
a trailer;
a solar panel array disposed on the trailer;
a pole disposed on the trailer and having the solar panel array rotatably mounted thereon, wherein
the pole is extendable and the solar panel is rotatable about the pole about at least two axes;
a plurality of batteries disposed on the trailer and in communication with the solar panel array;
a crank shaft in communication with the pole, wherein
the crank shaft can adjust an extension of the pole and an orientation of the solar panel array;
a plurality of electrical outlets in communication with the plurality of batteries and in communication with the solar panel array;
an artificial intelligence control system configured to position the solar panel array based on a positioning of the sun and a geographical positioning of the solar panel array.

2. The solar panel system of claim 1, wherein the trailer is a two-axle flatbed trailer with a plurality of outriggers.

3. The solar panel system of claim 1, wherein the plurality of batteries are configured to provide power to an external structure.

4. The solar panel system of claim 1, wherein the artificial intelligence control system is configured to detect an obstruction of sunlight and position the solar panel array away from the obstruction of sunlight.

5. The solar panel system of claim 1, wherein the plurality of electrical outlets includes six electrical outlines disposed on the trailer and configured to communicate with extension cables.

6. The solar panel system of claim 1, wherein the trailer is a two-axle flatbed trailer including four outriggers, one of each of the four outriggers is disposed on a corner of the trailer, and the four outriggers are configured to stabilize the trailer.
